(19) United States
(12) Patent Application Publication
(10) Pub. No.: US 2008/0031123 A1
(43) Pub. Date: Feb. 7, 2008

(54) Embossed type write-once recording medium structure

(76) Inventors: Wu-Hsuan Ho, Hsinchu Hsien (TW); Chung-Ping Wang, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/498,237

(22) Filed: Aug. 3, 2006

(51) Int. Cl. G11B 7/24

(52) U.S. Cl. 369/275.1

(57) ABSTRACT

An embossed type write-once DVD structure comprises a lower substrate, a recording layer, a reflecting layer and an upper substrate. Embossed marks of a specific depth are formed on the lower substrate. The recording layer has a specific refractive index and is formed on the lower substrate. The reflecting layer covers on the recording layer. The upper substrate is then sealed with the lower substrate to protect each layer therein. Different laser sources can be used for data recording. The lower substrate with embossed marks can be produced using a stamper. Therefore, it is not necessary to use a laser source to emboss in the recording layer. The manufacturing cost can thus be lowered, and the production yield can be enhanced through simplification of the manufacturing process.

### BACKGROUND OF THE INVENTION

1. Field of the invention

The present invention relates to a write-once recording medium structure and, more particularly, to an embossed type write-once recording medium structure.

2. Description of Related art

Although the motive of R&D of digital recording media is initially only for the application of home digital video, the media nowadays with different structures and characteristics are then developed for more and more various applications. The media can be mainly classified into three kinds: read-only recording media, write-once recording media and rewritable/erasable recording media. DVD-ROM is a common read-only recording media. Common write-once recording media include DVD-R and DVD+R. Common rewritable/erasable recording media include DVD-RW, DVD+RW and DVD-RAM. Because different types of recording media have different coverage of applications, they have different specifications and manufacturing flow processes. No matter what type of a recording medium is, however, data is recorded in the recording medium through photoreaction. Therefore, it is necessary to first define control data such as recording media manufacturer, recording media type, allowable data capacity, and recording strategy in regions where data to be recorded so that related disc information can be provided for a recording device when recording data into the disc to allow the recording device to be able to correctly identify the disc and also enhance the recording quality.

As shown in FIG. 1(a), FIG. 1(b) and FIG. 1(c), an apparent structure of a traditional recording medium is revealed in FIG. 1(a), the morphology of the recording layer (the A area in FIG. 1(a)) is revealed in FIG. 1(b) and the cross-sectional diagram of the whole structure is revealed in FIG. 1(c). According to the FIG. 1(a)-(c), the structure of a prior art of the write-once recording medium comprises a lower substrate 10, a recording layer 12, a reflecting layer 14 and an upper substrate 16, wherein a plurality of groove 181 and land 182 are formed in the recording layer 12. In the traditional method of recording, both of the common data recording area 18 the control data recording area 18′ are recorded within the region of the groove 181. For instance, a plurality of control data recording areas 18′ are prerecorded in the groove 181 of the recording layer 12, where a plurality of the common data recoding areas 18 are going to be recorded later, using laser 40 to record all control data required for recording and reading of the write-once recording medium. The above method of using laser 40 for prerecording, however, will consume laser energy fast and considerably due to continual manufacturing process, hence causing a very large cost burden to manufactures of mass production. Moreover, because of an extra production step, the whole production yield will be deteriorated. Therefore, the method of using laser for recording is not ideal in consideration of long-term production.

The present invention aims to propose an embossed type write-once recording medium structure to solve the above problems in the prior art. A stamper of lower substrate with embossed marks is used to form a lower substrate with embossed marks. After the whole manufacturing process of the write-once recording medium is finished, it is not necessary to record control data using laser.

### SUMMARY OF THE INVENTION

An object of the present invention is to provide an embossed type write-once recording medium structure, which uses a lower substrate with embossed marks of specific depth as the substrate so that marks can be directly formed on a recording layer covering on the lower substrate. Because it is not necessary to record marks on the recording layer via laser, the cost can be effectively lowered, and the manufacturing yield can be enhanced.

Another object of the present invention is to provide an embossed type write-once recording medium structure, in which a recording layer of specific refractive index is directly formed on a lower substrate with embossed marks by means of spin coating. Because it is not necessary to add extra manufacturing steps, no burden to the manufacturing process will be increased, and the manufacturing yield won't be affected.

To achieve the above objects, the present invention provides an embossed type write-once recording medium structure, which comprises a lower substrate, a recording layer, a reflecting layer and an upper substrate. Embossed marks of specific depth are formed on the lower substrate. The recording layer is formed on the lower substrate to cover on these embossed marks so as to directly form a plurality of marks of control data. The reflecting layer is formed on the recording layer to reflect laser for recording. The upper substrate has a smooth inner surface, and is sealed with the lower substrate to protect the recording layer and the reflecting layer therein. Moreover, the combination of both upper and lower substrates can strengthen the whole structure of the recording medium. In the present invention, laser-prerecording marks are replaced with the special design of a stamper. The present invention not only can easily emboss marks, but can also effectively lower the manufacturing cost and enhance the manufacturing yield.

### BRIEF DESCRIPTION OF THE DRAWINGS

The various objects and advantages of the present invention will be more readily understood from the following detailed description when read in conjunction with the appended drawing, in which:

FIG. 1(a) is an apparent structure of a traditional recording medium;

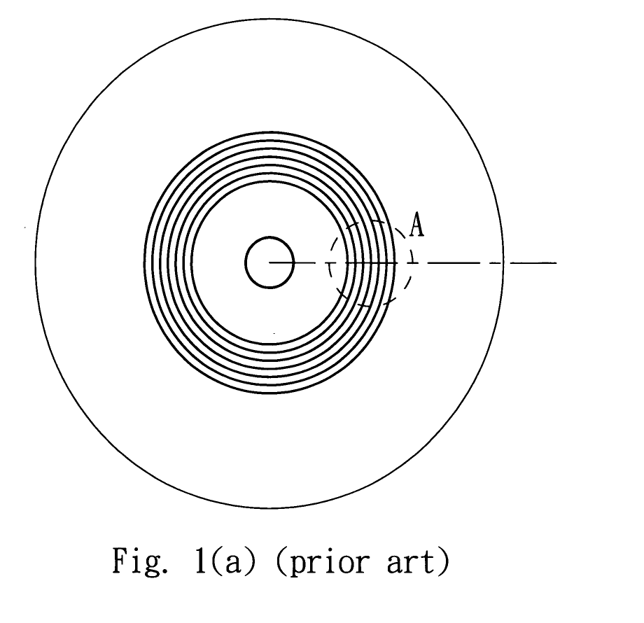

FIG. 1(b) is a the morphology of the recording layer of the traditional recording medium (the A area in FIG. 1(a));

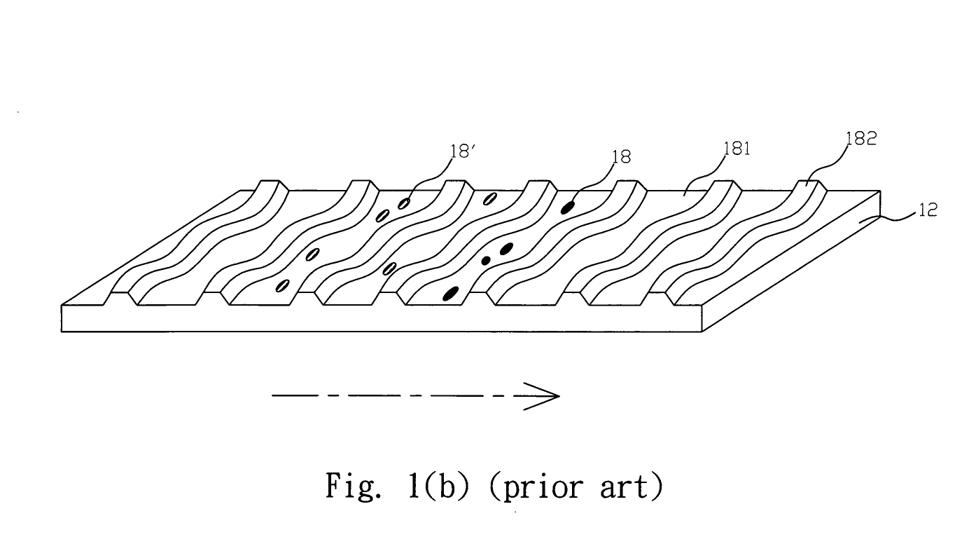

FIG. 1(c) is a cross-sectional structure diagram of the traditional recording medium;

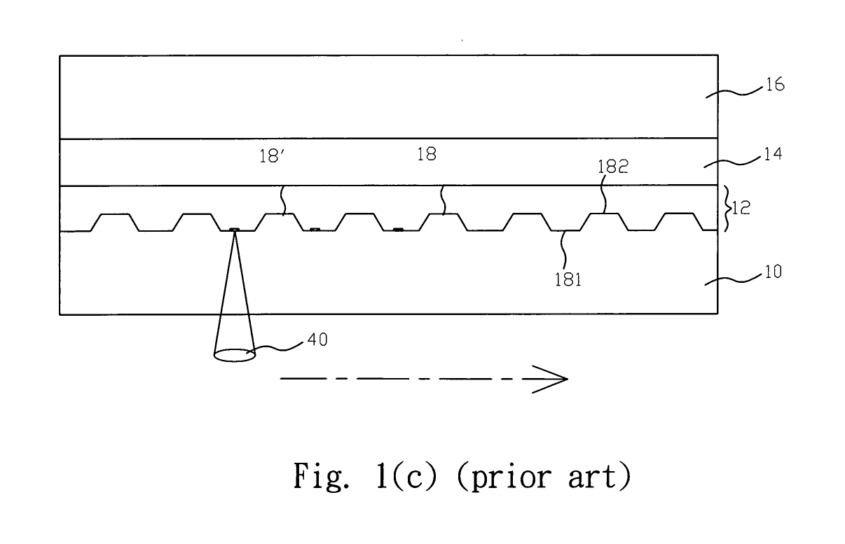

FIG. 2(a) is an apparent structure of an embossed type write-once recording medium of the present invention;

FIG. 2(b) is a the morphology of the recording layer of the embossed type write-once recording medium of the present invention (the B area in FIG. 2(a));

FIG. 2(c) is a cross-sectional structure diagram of the embossed type write-once recording medium of the present invention;

FIG. 3 is a cross-section view of a single-layer structure HDDVD-R; and

FIG. 4 is a cross-section view of a double-layer structure HDDVD-R.

### DETAILED DESCRIPTION OF THE PREFERRED EMBODIMENT

In order to enhance the recording quality of recording medium, basic control data is required. Especially, the control data marks in today's write-once recording medium are formed using laser writing in the follow-up step. This method of forming prerecorded marks in write-once recording medium, however, has a very high manufacturing cost. Moreover, there is the problem of a relatively lower manufacturing yield. In consideration of the above problems, the present invention provides an embossed type write-once recording medium structure.

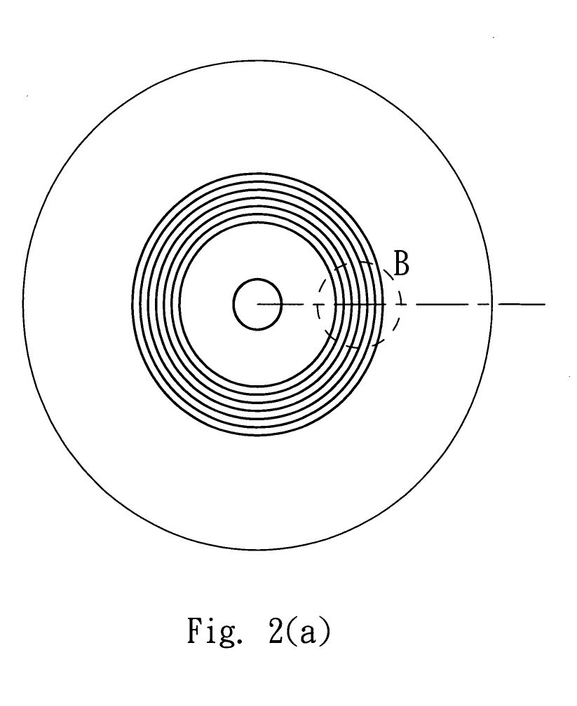

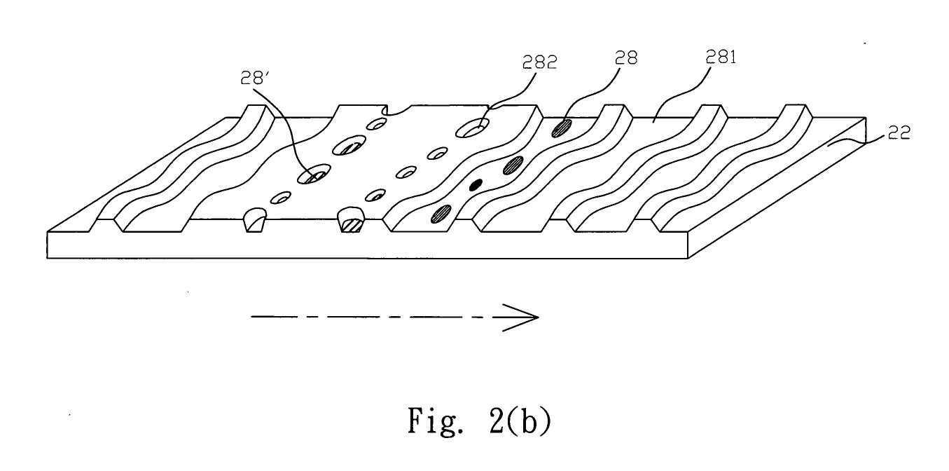

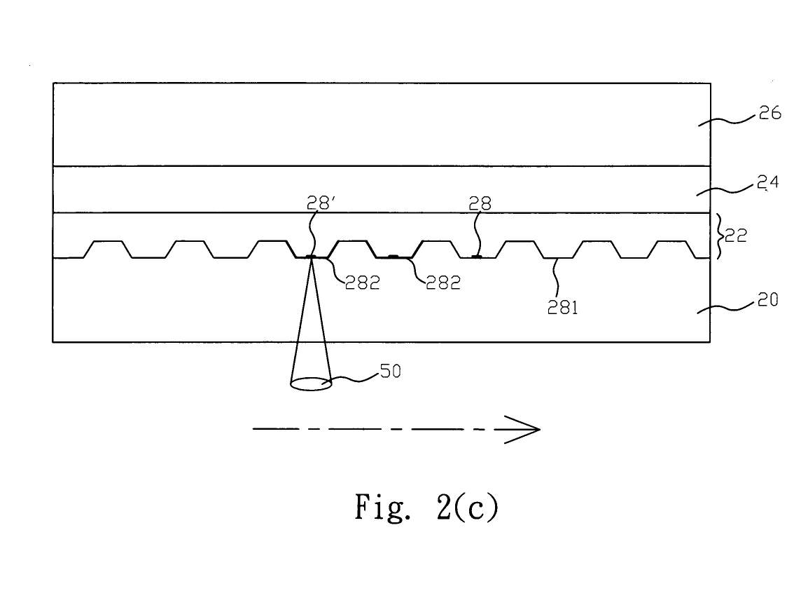

As shown in FIG. 2(a), FIG. 2(b) and FIG. 2(c), an apparent structure of the embossed type write-once recording medium is revealed in FIG. 2(a), the morphology of the recording layer (the B area in FIG. 2(a)) is revealed in FIG. 2(b) and the cross-sectional diagram of the whole structure is revealed in FIG. 2(c). According to the FIG. 2(a)-(c), the structure of embossed type write-once recording medium comprises a lower substrate 20, a recording layer 22, a reflecting layer 24 and an upper substrate 26, wherein a circular area near by the center is rounded by a plurality of embossed pits 282 and next to these embossed pits 282 are plurality of grooves 281. In this invention, a plurality of control data recording area 28′ is formed only in the embossed pits 282 by using laser 50 while a plurality of common data recording area 28 is only formed in the grooves 281 by using laser as well. Under the condition that a red laser of wavelength 650 nm is used as the light source, the depth of the embossed pits 282 is between 100 and 170 nm. Under the condition that a blue laser of wavelength 405 nm is used as the light source, the depth of the embossed pits 282 is between 40 and 85 nm. The recording layer 22 covers on the lower substrate 20. The recording layer 22 has a specific range of refractive index to prevent optical noise between the lower substrate 20 having the embossed pits 282 and the recording layer 22 during the process of spin coating. The ideal refractive index of the recording layer has a direct relation with the light source used. For instance, under the condition that a red laser of wavelength 650 nm is used as the light source, the ideal refractive index of the recording layer 22 is between 1.7 and 2.3; under the condition that a blue laser of wavelength 405 nm is used as the light source, the ideal refractive index of the recording layer 22 is between 1.1 and 1.7. The reflecting layer 24 covers on the recording layer 22. The reflecting layer 24 is usually made of silver or silver alloy. Finally, the upper substrate 26 is sealed with the lower substrate 20 to wrap up the recording layer 22 and the reflecting layer 24 as well as to strengthen the mechanical properties of the whole structure so as to achieve the effects of protection and robustness.

The material of the above lower substrate and upper substrate is generally polycarbonate. The lower substrate can be shaped with a stamper embossed with marks. Because the stamper can be used repetitively, the manufacturing cost of the write-once recording medium can be lowered. Typically, the thickness lower substrate and upper substrate is equivalent. In this embodiment, the lower substrate and the upper substrate are both in the thick of 0.6 mm.

The ideal range of refractive index and the ideal range of depth of embossed marks proposed in the present invention will be verified below with some test data.

In order to reduce the optical noise when the recording layer is spin coated on the lower substrate with embossed marks, recording materials of different refractive indices are tested. As shown in Table 1, a red laser of wavelength of 650 nm is used as the recording light source. Four recording materials: recording material A, recording material B, recording material C and recording material D have refractive indices of 2.487, 2.452, 2.193 and 1.966, respectively. Under the condition that the depth of embossed marks is 160 nm, the data-to-clock jitter (DC jitter) are 20.75%, 16.08%, 8.5% and 12.04%, respectively. Therefore, recording material C and recording material D are preferred. This test result shows that the refractive index of the recording layer is preferred to be between 1.96 and 2.19, which indeed conforms to the ideal range of the refractive index (1.7 to 2.3) proposed in the present invention.

TABLE 1

| Type of | | Depth | |
|---|---|---|---|
| recording | Refractive | of embossed | Least DC |
| material | index | marks (nm) | jitter (%) |
| A | 2.487 | 160 | 20.75 |
| B | 2.452 | 160 | 16.08 |
| C | 2.193 | 160 | 8.5 |
| D | 1.966 | 160 | 12.04 |

After obtaining the preferred range of refractive index, a feasible range of depth is proposed to be 100 to 170 nm according to the above depth of embossed marks. Similarly, under the condition that a red laser of wavelength of 650 nm is used as the light source, the optimization of the depth of embossed marks is carried out. The same four recording materials: recording material A, recording material B, recording material C and recording material D are used. DC jitters of these four recording materials with a specific optical density of the recording layer are collected for different depths of embossed marks. It is found that in the feasible range of depth, the depth is preferred to be between 120 and 160 nm. As shown in Table 2, the provided data give first place to recording material C and recording material D and are assisted by partial test data of the less ideal recording materials: recording material A and recording material B. However, regardless of the more ideal recording materials: recording material C and recording material D or the less ideal recording materials: recording material A and recording material B, the data in Table 2 shows that the preferred depth of embossed marks is between 120 and 160 nm, within which the DC jitter of every recording material is lower. With recording material C and recording material D as the examples, when the depth of embossed marks is between 120 and 160 nm, the obtained DC jitter is between 8.5% and 16.53%. Moreover, the data in Table 2 echo the result in Table 1. That is, under the same depth of embossed marks, the obtained DC jitters of recording material C and recording material D are evidently lower than those of recording material A and recording material B. Besides, under the situation that the optimum depth of embossed marks matches the more ideal recording layer (e.g., the optical density of the recording layer), the obtained write-once recording medium has a good focusing function and a normal tracking function.

TABLE 2

| Depth of | Recording | Recording | Recording | Recording |
|---|---|---|---|---|
| embossed | material A | material B | material C | material D |
| marks, nm | DC jitter (%) | DC jitter (%) | DC jitter (%) | DC jitter (%) |
| 180 | — | — | — | 15.15 |
| 160 | 20.85 | 16.08 | 8.5 | 12.04 |
| 160 | 20.75 | 18.95 | 12.78 | — |
| 160 | — | — | 12.61 | — |
| 120 | — | 18.95 | 10.52 | — |
| 120 | — | — | 15.83 | — |
| 120 | — | — | 16.53 | — |
| 120 | — | — | 16.53 | — |

Additionally, the embossed type write-once recording medium structure of the present invention can further use a blue laser of wavelength of 405 nm as the light source. Because the wavelength of the light source that function on the recording layer is different, the matched recording materials are not exactly the same as those with the red laser of wavelength of 650 nm as the light source. Table 3 shows the obtained least DC jitters under the condition of a fixed depth of embossed marks with the blue laser of wavelength of 405 nm as the light source for three different recording materials: recording material D, recording material E and recording material F. Recording material D, recording material E and recording material F have refractive indices of 1.401, 1.412 and 1.289, respectively. Under the condition that the depth of embossed marks is between 60 and 63 nm, the obtained DC jitters are 6.2%, 7.6% and 6.6%, respectively. Therefore, it can be inferred that the preferred recording materials are recording material D and recording material F. This test result shows that the preferred refractive index of the recording layer is between 1.289 and 1.40, which indeed conforms to the ideal range of the refractive index (1.1 to 1.7) proposed in the present invention.

TABLE 3

| Type of recording | | Depth of embossed | Least |
|---|---|---|---|
| material | Refractive index | marks (nm) | DC jitter (%) |
| D | 1.401 | 60~63 | 6.2 |
| E | 1.412 | 60~63 | 7.6 |
| F | 1.289 | 60~63 | 6.6 |

After obtaining the preferred range of refractive index, a feasible range of the depth of embossed marks is proposed to be 40 to 85 nm according to the above depth. The preferred recording material, recording material D, is used to select the range of the depth of embossed marks. As shown in Table 4, the test targets are set to the range between 50 and 73 nm. With the blue laser of wavelength of 405 nm as the light source, the obtained DC jitters are between 6.2% and 8.1%. From these data, if a recording material with a good refractive index is selected, the range of the depth of embossed marks from 50 to 73 nm is feasible with the blue laser as the light source. This indeed conforms to the ideal range of the depth of embossed marks (40 to 85 nm) proposed in the present invention.

TABLE 4

| Depth of embossed marks (nm) | Least DC jitter (%) |
|---|---|
| 73 | 6.5~7.7 |
| 67~68 | 6.2~6.7 |
| 65~66 | 64~7.3 |
| 60~63 | 7.8~8.1 |
| 50~52 | 6.7~7.5 |

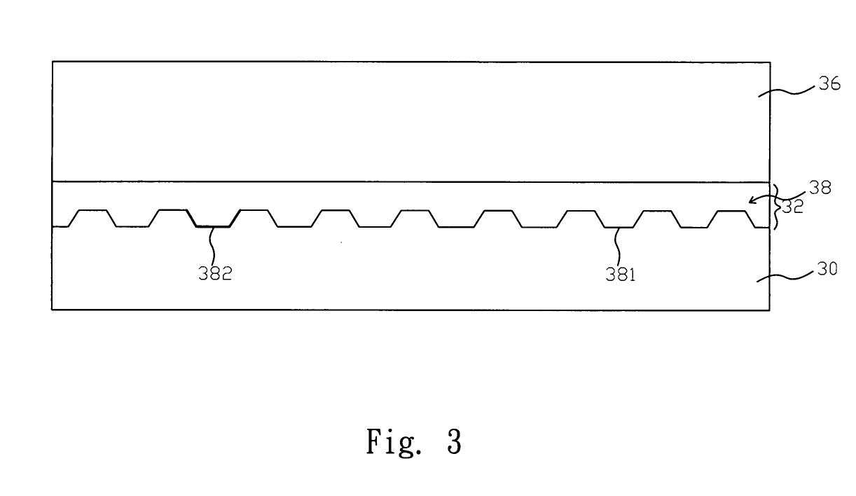

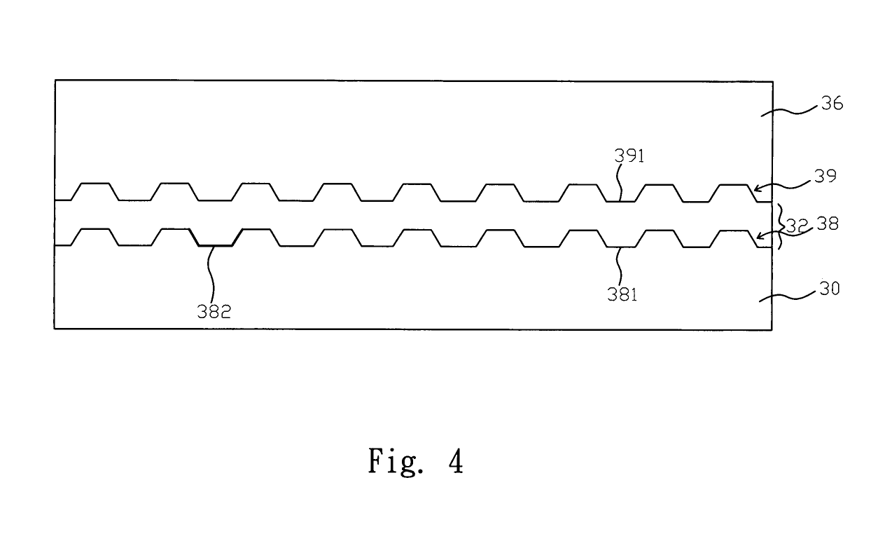

Additionally, the embossed type write-once recording medium structure of the present invention can be used in the different products such as the red laser write-once DVD-R, the blue laser single-layer structure HDDVD-R, the blue laser double-layer structure HDDVD-R and any kinds of the DVD-R structures. Refer to FIG. 3 and FIG. 4, the cross-section views of the single-layer-structure HDDVD-R and the double-layer-structure HDDVD-R above mentioned are shown individually. In FIG. 3, a first recording layer 38 is formed in one surface of the recording layer 32 of the HDDVD-R due to a single-layer structure. Within the first recording layer 38, both of the grooves 381 and the embossed pits 382 are formed. In FIG. 4, a first recording layer 38 and a second recording layer 39 are formed individually in two surfaces of the recording layer 32 of the HDDVD-R due to a double-layer structure. Within the first recording layer 38 is similar to what mentioned above, both of the grooves 381 and the embossed pits 382 are formed while within the second recording layer 39, a lead out area 391 is formed. And the same as what mentioned previously, the lower substrate 30 and the upper substrate 36 are generally equivalent in thickness. Take this embodiment as an instance, the lower substrate 30 is in a thickness of 0.6 mm, equaling to the thickness of the upper substrate 36.

To sum up, the embossed type write-once recording medium structure of the present invention can use embossed marks on the lower substrate to replace marks recorded by laser in the prior art. In the aspect of recording-medium-processing, it not only can effectively get rid of use of laser to lower the cost, but can also simplify the manufacturing process to relatively enhance the manufacturing yield and further reduce the manufacturing cost.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. An embossed type write-once recording medium structure comprising:
a lower substrate having a plurality of embossed marks;
a recording layer formed on said lower substrate and covering on said embossed marks, said recording layer using a plurality of tracks to store data;
a reflecting layer formed on said recording layer and used to reflect light from a light source used for recording to let said tracks in said recording layer have sufficient energy for photochemical reaction; and
an upper substrate formed on said reflecting layer and sealed with said lower substrate to protect said recording layer and prevent said reflecting layer from scratches.

2. The embossed type write-once recording medium structure as claimed in claim 1, wherein said embossed marks are used to record a plurality of control data, and said control data is selected among disc type, manufacturer information, recording capacity and recording strategy.

3. The embossed type write-once recording medium structure as claimed in claim 1, wherein said lower substrate is shaped with a metal stamper that is embossed with said marks.

4. The embossed type write-once recording medium structure as claimed in claim 1, wherein the material of said lower substrate is polycarbonate.

5. The embossed type write-once recording medium structure as claimed in claim 1, wherein the material of said upper substrate is polycarbonate.

6. The embossed type write-once recording medium structure as claimed in claim 1, wherein under the condition that a red laser of wavelength 650 nm is used as the light source, the depth of said marks is between 100 and 170 nm.

7. The embossed type write-once recording medium structure as claimed in claim 6, wherein the depth of said marks is preferred to be between 120 and 160 nm.

8. The embossed type write-once recording medium structure as claimed in claim 1, wherein under the condition that a blue laser of wavelength 405 nm is used as the light source, the depth of said marks is between 40 and 85 nm.

9. The embossed type write-once recording medium structure as claimed in claim 1, wherein said recording layer is of write-once type.

10. The embossed type write-once recording medium structure as claimed in claim 1, wherein the material of said recording layer is organic material or inorganic m material.

11. The embossed type write-once recording medium structure as claimed in claim 1, wherein under the condition that a red laser of wavelength 650 nm is used as the light source, the refractive index of said recording layer is between 1.7 and 2.3.

12. The embossed type write-once recording medium structure as claimed in claim 1, wherein under the condition that a blue laser of wavelength 405 nm is used as the light source, the refractive index of said recording layer is between 1.1 and 1.7.

13. The embossed type write-once recording medium structure as claimed in claim 1, wherein said recording layer can be formed by means of spin coating.

14. The embossed type write-once recording medium structure as claimed in claim 1, wherein the material of said reflecting layer is silver or silver alloy.
